(19) United States
(12) Patent Application Publication
(10) Pub. No.: US 2013/0153120 A1
(43) Pub. Date: Jun. 20, 2013

(54) METHOD FOR MAKING BREATHABLE ELASTIC LAMINATE

(71) Applicant: Shing Jiu SHEU, Taipei (TW)

(72) Inventor: Shing Jiu SHEU, Taipei (TW)

(21) Appl. No.: 13/491,401

(22) Filed: Jun. 7, 2012

(30) Foreign Application Priority Data
Dec. 16, 2011 (TW) 100146823

(51) Int. Cl. B32B 37/06; B32B 37/14

(52) U.S. Cl. 156/82

(57) ABSTRACT

A method for making a breathable elastic laminate includes: (a) flame-treating a surface of a PU foam layer such that the surface of the PU foam layer is formed with a plurality of molten spots; and (b) disposing a breathable elastic layer over the molten spots such that the breathable elastic layer is adhered to the PU foam layer through the molten spots.

### CROSS-REFERENCE TO RELATED APPLICATION

This application claims priority of Taiwanese application no. 100146823, filed on Dec. 16, 2011.

### BACKGROUND OF THE INVENTION

1. Field of the Invention

This invention relates to a method for making an elastic laminate, and more particularly to a method for making a breathable elastic laminate.

2. Description of the Related Art

Foamed neoprene is a type of synthetic rubber foam that has elastic, damping, thermal insulating, water impermeable, and air impermeable properties. Neoprene material is widely used in manufacturing diving clothes, sport protectors, medical protectors, body shapers, thermal insulation cup covers and shoes. As shown in FIG. 1, a conventional neoprene cloth 1 is made from a laminated composite material including a neoprene layer 13 that is sandwiched between upper and lower breathable clothes 11, 12. Since the neoprene layer 13 with close cells is water and air impermeable, a wearer who wears the sport protectors, the medical protectors, or the body shapers that are made of the conventional neoprene cloth 1 may feel uncomfortable because no heat and sweat 10 can escape from the wearer's body. To overcome this disadvantage, the neoprene layer 13 is punched to form a plurality of breathable holes 14 so that the heat and sweat 10 is allowed to escape from the wearer's body through the breathable holes 14 (see FIG. 2). Although the heat and sweat 10 can partially escape from the wearer's body, the heat and sweat 10 generated from the parts of the wearer's body that are covered by the neoprene layer 13 and that are not exposed from the breathable holes 14 may not escape from the wearer's body. Therefore, the wearer may still feel sultry and uncomfortable.

In addition, the laminated composite material is generally formed by a compression molding process. This will result in a reduction of the thickness of the elastic composite material and variation of the hardness and density of the elastic composite material, thereby adversely affecting the elasticity thereof.

### SUMMARY OF THE INVENTION

Therefore, an object of the present invention is to provide a method for making a breathable elastic laminate with good breathability.

According to this invention, there is provided a method for making a breathable elastic laminate, which comprises:

(a) flame-treating a surface of a polyurethane foam layer such that the surface of the polyurethane foam layer is formed with a plurality of molten spots; and

(b) disposing a breathable elastic layer over the molten spots such that the breathable elastic layer is adhered to the polyurethane foam layer through the molten spots.

### BRIEF DESCRIPTION OF THE DRAWINGS

Other features and advantages of the present invention will become apparent in the following detailed description of a preferred embodiment of the invention, with reference to the accompanying drawings, in which:

FIG. 1 is a schematic view of a conventional neoprene cloth;

FIG. 2 is a schematic view of a conventional neoprene cloth that has a neoprene layer with a plurality of breathable holes;

FIG. 3 is a flow chart of the preferred embodiment of a method for making a breathable elastic laminate according to the present invention;

FIG. 4 is a schematic view illustrating a step of flame-treating a first surface of a polyurethane foam layer such that the first surface of the polyurethane foam layer is formed with a plurality of first molten spots, and a step of disposing a first breathable elastic layer over the first molten spots of the method of the preferred embodiment;

FIG. 5 is a schematic view illustrating a step of flame-treating a second surface of the polyurethane foam layer opposite to the first surface such that the second surface of the polyurethane foam layer is formed with a plurality of second molten spots, and a step of disposing a second breathable elastic layer over the second molten spots such that the second breathable elastic layer is adhered to the polyurethane foam layer through the second molten spots of the method of the preferred embodiment;

FIG. 6 is a schematic view illustrating a breathing state of a breathable elastic laminate made by the preferred embodiment of FIG. 3;

FIG. 7 is a schematic view of a band-like product made by the method of this invention;

FIG. 8 is a schematic view of a tubular product made by the method of this invention; and

FIG. 9 is a schematic view of a variety of products made by the method of this invention, the products being worn on various parts of a wearer.

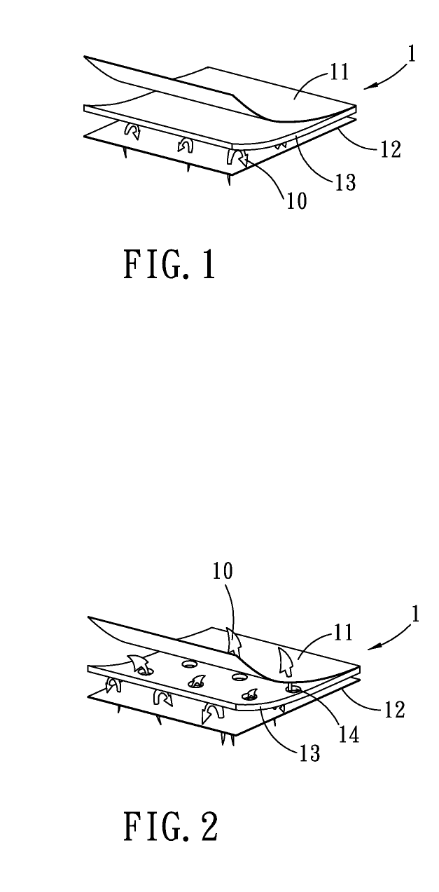

### DETAILED DESCRIPTION OF THE PREFERRED EMBODIMENT

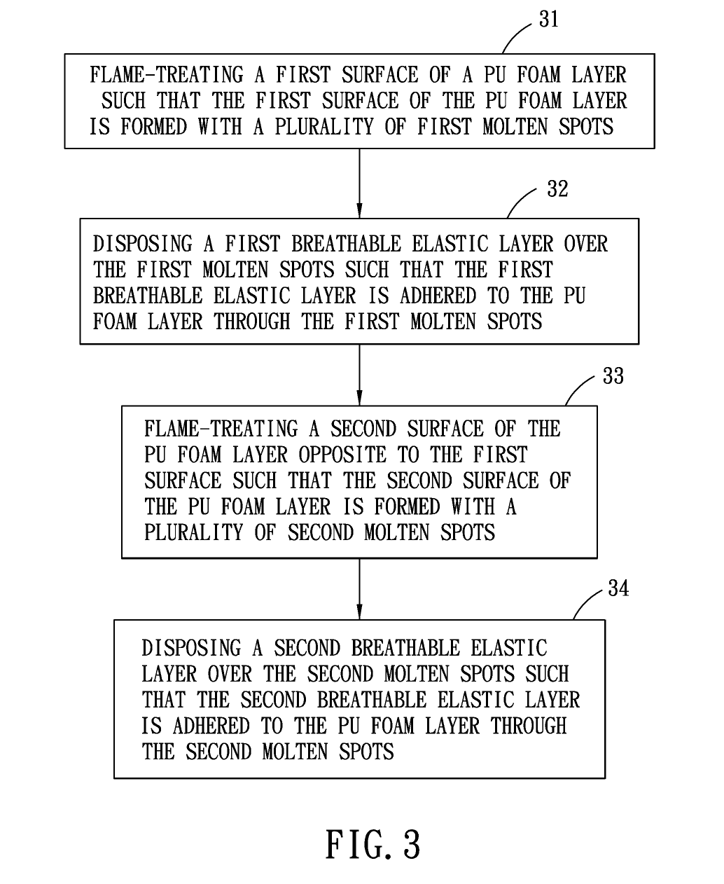

Referring to FIG. 3, the preferred embodiment of a method for making a breathable elastic laminate of the present invention comprises steps 31 to 34.

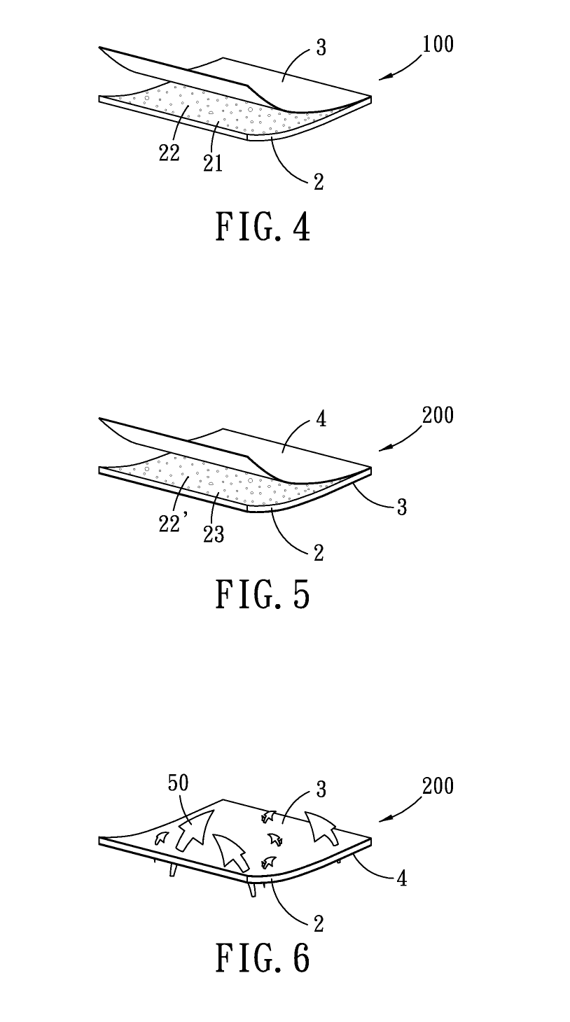

Referring to FIG. 4, in step 31, a first surface 21 of a polyurethane (PU) foam layer 2 is flame-treated such that the first surface 21 of the PU foam layer 2 is formed with a plurality of first molten spots 22. Thereafter, in step 32, a first breathable elastic layer 3 is disposed over the first molten spots 22 such that the first breathable elastic layer 3 is adhered to the first surface 21 of the PU foam layer 2 through the first molten spots 22. A double-layered breathable elastic laminate 100 is thus formed.

Next, as shown in FIG. 5, in step 33, a second surface 23 of the PU foam layer 2 opposite to the first surface 21 is flame-treated such that the second surface 23 of the PU foam layer 2 is formed with a plurality of second molten spots 22′. Thereafter, in step 34, a second breathable elastic layer 4 is disposed over the second molten spots 22′ such that the second breathable elastic layer 4 is adhered to the second surface 23 of the PU foam layer 2 through the second molten spots 22′. Finally, a triple-layered breathable elastic laminate 200 is thus formed.

More specifically, the PU foam layer 2 has open cells and thus exhibits an excellent breathable property. Each of the first breathable elastic layer 3 and the second breathable elastic layer 4 is made of a well known breathable elastic cloth, such as spandex, jersey, terrycloth, or mercerized cloth. The first surface 21 and the second surface 23 of the PU foam layer 2 are flame-treated such that the first surface 21 and the second surface 23 are slightly melted but not burnt. Therefore, no toxic gas will be generated in the method of this invention, and such method is more environmentally friendly. After the first and second molten spots 22, 22′ are formed, the first surface 21 and the second surface 23 of the PU foam layer 2 are adhered to the first breathable elastic layer 3 and the second breathable elastic layer 4, respectively, and the first and second molten spots 22, 22′ permeate respectively into the cloth fibers of the first breathable elastic layer 3 and the second breathable elastic layer 4. Thus, no glue is required to adhere the PU foam layer 2 to the first breathable elastic layer 3 and the second breathable elastic layer 4, and the breathable property of the PU foam layer 2 may not be adversely affected. Therefore, the triple-layered breathable elastic laminate 200 made of the PU foam layer 2, the first breathable elastic layer 3 and the second breathable elastic layer 4 may have an excellent breathable property and may not become hardened.

As shown in FIG. 6, when the triple-layered breathable elastic laminate 200 of this preferred embodiment is applied to a wearer's body, the heat and sweat 50 from the wearer's body may escape through the opened cells in the PU foam layer 2 to the external environment. Therefore, the wearer may feel comfortable, and may not feel sultry even after a long period of wearing.

In addition, the PU foam layer 2 is made of a material that has excellent elasticity, extensibility and tear resistance comparable to those of the neoprene material, and that is lighter than the neoprene material. Furthermore, unlike the neoprene material that is a thermosetting material and thus may not be re-melted and re-shaped in a rework process and the shape thereof may only be changed by means of a tailoring process, the PU foam layer 2 is made of a thermoplastic material and can be re-melted and re-shaped. Therefore, the PU foam layer 2 may be formed into a variety of shapes.

In addition, because the double layered breathable elastic laminate 100 and the triple-layered breathable elastic laminate 200 are made in a manner that is different from that of the conventional elastic laminate formed by a compression molding process, thickness of the double layered breathable elastic laminate 100 or the triple-layered breathable elastic laminate 200 may not be reduced, and the hardness and the density of the double layered breathable elastic laminate 100 or the triple-layered breathable elastic laminate 200 may not be changed, thereby providing a four-way stretch property.

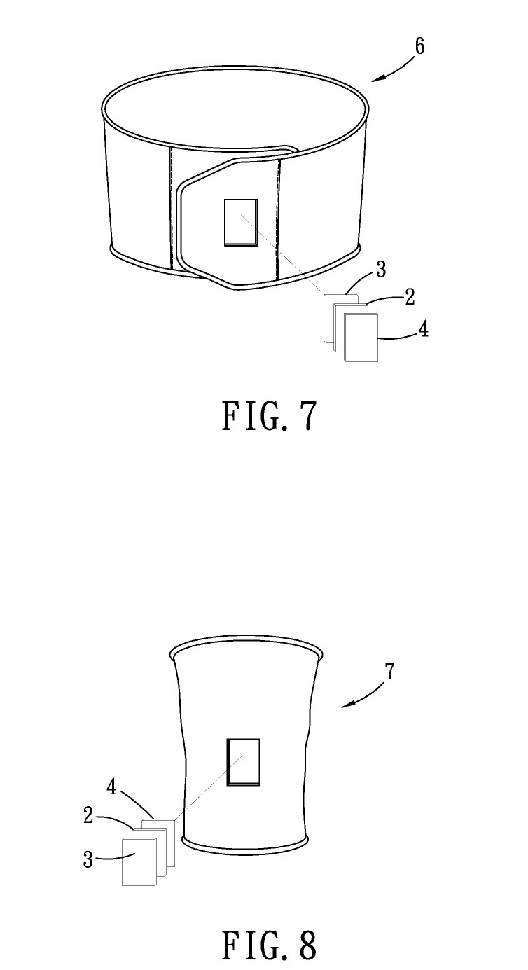

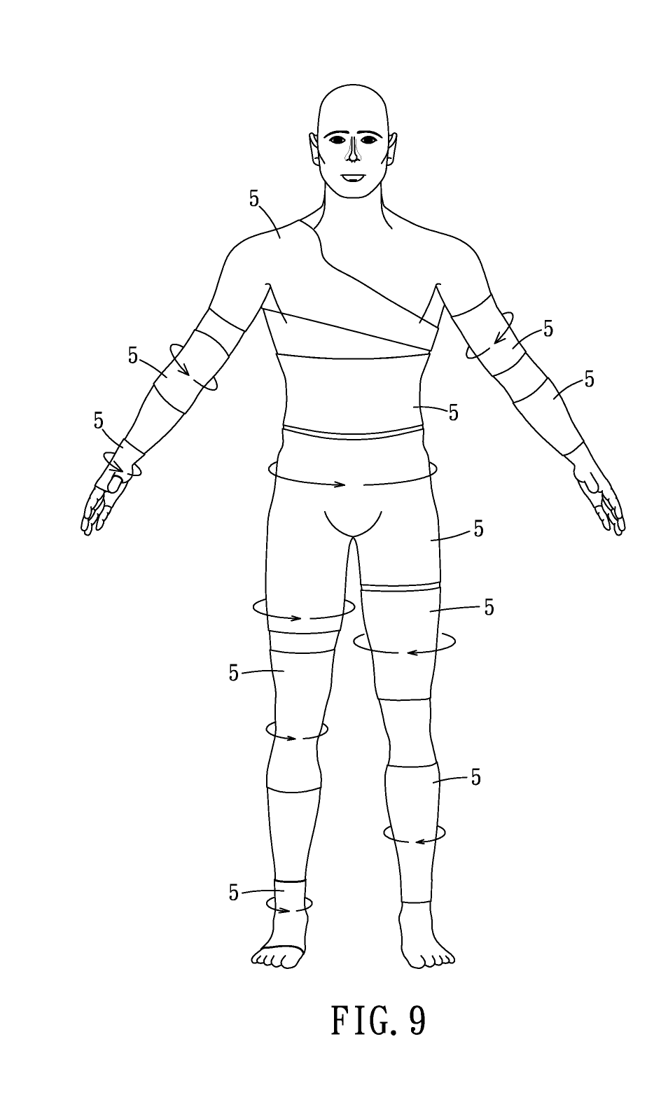

Referring to FIGS. 7 and 8, the triple-layered breathable elastic laminate 200 made from the method of this invention may be made into a band-like product 6 or a tubular product 7 for sports or medical use. In addition, as shown in FIG. 9, the triple-layered breathable elastic laminate 200 may be made into products 5 for wrapping different parts of the wearer's body, for example, thermal insulation clothes, thermal insulation trousers, thermal insulation masks, forehead protectors, neck protectors, shoulder protectors, chest protectors, back protectors, waist protectors, upper arm protectors, elbow protectors, lower arm protectors, wrist protectors, palm protectors, finger protectors, hand protectors, leg protectors, knee protectors, shin protectors, angle protectors, foot protectors, etc.

In addition, in consideration of cost saving, the product 5, the band-like product 6 or the tubular product 7 can be made of the double layered breathable elastic laminate 100 as illustrated in FIG. 4.

To sum up, in this invention, the first breathable elastic layer 3 and the second breathable elastic layer 4 can be adhered to the PU foam layer 2 with good breathable property by virtue of the molten spots 22 that are formed by flame-treating the PU foam layer 2, and thus the breathable property of the PU foam layer 2 may not be adversely affected. Therefore, when the triple-layered breathable elastic laminate 200 of this preferred embodiment is applied to a wearer's body, the heat and sweat from the wearer's body may escape through the opened cells in the PU foam layer 2 to the external environment, thereby making the wearer comfortable. In addition, unlike the conventional neoprene cloth, the PU foam layer 2 of the present invention does not need to be punched for venting purpose, and the manufacturing cost of the method of the present invention can be reduced.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A method for making a breathable elastic laminate, comprising:
(a) flame-treating a first surface of a PU foam layer such that the first surface of the PU foam layer is formed with a plurality of first molten spots; and
(b) disposing a first breathable elastic layer over the first molten spots such that the first breathable elastic layer is adhered to the PU foam layer through the first molten spots.

2. The method of claim 1, wherein the first breathable elastic layer is made of a material selected from spandex, jersey, terrycloth, and mercerized cloth.

3. The method of claim 1, further comprising:
(c) flame-treating a second surface of the PU foam layer opposite to the first surface such that the second surface of the PU foam layer is formed with a plurality of second molten spots; and
(d) disposing a second breathable elastic layer over the second molten spots such that the second breathable elastic layer is adhered to the PU foam layer through the second molten spots.

4. The method of claim 3, wherein the second breathable elastic layer is made of a material selected from spandex, jersey, terrycloth, and mercerized cloth.
